(19) United States
(12) Patent Application Publication
(10) Pub. No.: US 2026/0361530 A1
(43) Pub. Date: Nov. 12, 2026

(54) KEY SHARE REFRESH IN ASSOCIATION WITH KEY SHARE OPERATIONS

(71) Applicant: Coinbase, Inc., Oakland, CA (US)

(72) Inventors: Guy Pe'er, Talmey Yechiel (IL); Yehuda Lindell, Petah Tikva (IL); Nir Steinherz, Tel Aviv (IL)

(21) Appl. No.: 19/205,660

(22) Filed: May 12, 2025

(51) Int. Cl. H04L 9/08

(52) U.S. Cl. CPC H04L 9/088

(57) ABSTRACT

Methods, systems, and devices for data management are described. An entity that may possess a key share of multiple key shares of a cryptographic key may receive a request to perform a cryptographic operation using the key share, where one or more other entities may possess respective other key shares of the multiple key shares. The entity may execute, with the one or more other entities after receiving the request, the cryptographic operation using the key share. After receiving the request, the entity may communicate, with the one or more other entities, first messaging configured to refresh the key share for the entity and the respective other key shares for the one or more other entities. After communicating the first messaging, the entity may possess a new key share of the cryptographic key and the one or more other entities may possess new respective key shares of the cryptographic key.

### FIELD OF TECHNOLOGY

The present disclosure relates generally to data management, including techniques for key share refresh in association with key share operations.

### BACKGROUND

Blockchains and related technologies may be employed to support recording of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports key share refresh in association with key share operations in accordance with aspects of the present disclosure.

FIG. 2 shows an example of a key share refresh diagram that supports key share refresh in association with key share operations in accordance with aspects of the present disclosure.

FIG. 3 shows an example of a process flow that supports key share refresh in association with key share operations in accordance with aspects of the present disclosure.

FIG. 4 shows a block diagram of an apparatus that supports key share refresh in association with key share operations in accordance with aspects of the present disclosure.

FIG. 5 shows a block diagram of a key share manager that supports key share refresh in association with key share operations in accordance with aspects of the present disclosure.

FIG. 6 shows a diagram of a system including a device that supports key share refresh in association with key share operations in accordance with aspects of the present disclosure.

FIGS. 7 through 10 show flowcharts illustrating methods that support key share refresh in association with key share operations in accordance with aspects of the present disclosure.

### DETAILED DESCRIPTION

In some systems, multiple parties in a multi-party computation (MPC) scheme may collaborate to perform an MPC operation. As part of the MPC scheme, a cryptographic key may be distributed, via multiple key shares, to multiple parties. For example, a cryptographic key, which may be an example of a secret signing key or a secret encryption key, may be split into multiple parts via a key sharing operation, such as Shamir sharing, additive sharing, multiplicative sharing, or the like. In some cases, a threshold quantity or all of the multiple parties having the key shares of the cryptographic key (i.e., t out of n key shares) may, together, perform an MPC operation. In other words, the threshold quantity of key shares may be required to execute the MPC operation. As described herein, “party” may refer to a participant in a protocol or scheme, such as a signer, a verifier, a sender, a receiver, or the like, and the participant may be a computing device (e.g., logical or physical computing system) that operates autonomously or with user input. Additionally, a “key share” may refer to a part or portion of a key or secret value and may be used interchangeably with “key shard” or “key part.” In some examples, distributing the key shares to different parties may increase security and reduce the risk of an attacker successfully acquiring the key. However, in some cases, an attacker may target each party individually to acquire the individual key shares. An attacker may target the individual parties over a long period of time to avoid raising an alarm.

In some cases, the parties of the MPC scheme may perform or be subject to a key share refresh operation. For example, a key share refresh operation may refer to the generation of new key shares which are different from previous key shares but correspond to the same key. In the example of the MPC scheme, the parties having the key shares may generate new key shares corresponding to the same cryptographic key as the original key shares. In some cases, the key share refresh operation may support proactive security. For example, the key shares may be refreshed before an attacker obtains all or a threshold quantity of key shares associated with execution of the MPC operation. In other words, while the attacker may obtain a first key share and, at a later time, a second key share, the first key share may not be compatible with the second key share due to a key share refresh operation occurring before the second key share is obtained.

The key share refresh operation may be an example of a cryptographic operation performed according to an MPC scheme. To perform the key share refresh operation, each party may bring respective key shares online (e.g., accessible at a network) in order to coordinate with the other parties for the key share refresh operation. However, bringing the key shares online may expose the key shares to potential attackers. For example, the key shares may be stored securely at the respective parties unless a cryptographic operation requiring the key shares or a key share refresh operation is performed. Then, the key shares may be brought online and made accessible via a network, providing an attack surface for attackers to attempt to steal key shares or the key.

The techniques described herein support refreshing key shares when key shares are brought online for a different cryptographic operation. For example, a party (e.g., entity) may receive a request to perform a cryptographic operation using a key share for a cryptographic key, where one or more other parties may possess other key shares for the cryptographic key. The parties may execute the cryptographic operation, which may include bringing the key shares online during a network session. During the same network session, the parties may coordinate to perform a key share refresh operation. For example, the same network session may be used to perform the cryptographic operation and the key share refresh operation, which may reduce the exposure of the key shares and reduce the vulnerability of the key shares.

In some cases, if a threshold duration passes after a key share refresh operation (e.g., during the same network session as a cryptographic operation), the parties may perform a second key share refresh operation, separate from another cryptographic operation. For example, to ensure the key shares may be refreshed periodically, the parties may perform key share refresh operations without associated cryptographic operations. In some cases, the parties may perform a second cryptographic operation and may not perform a key share refresh operation during the same network session. For example, the second cryptographic operation may be within a threshold duration from the cryptographic operation associated with the key share refresh operation. To reduce the time, energy consumption, and overhead associated with performing a key share refresh operation, if the key shares are not within a threshold period of time in which they may need to be refreshed, the parties may skip refreshing the key shares and may perform the second cryptographic operation without an associated key share refresh operation. These and other techniques are described in further detail with respect to the figures.

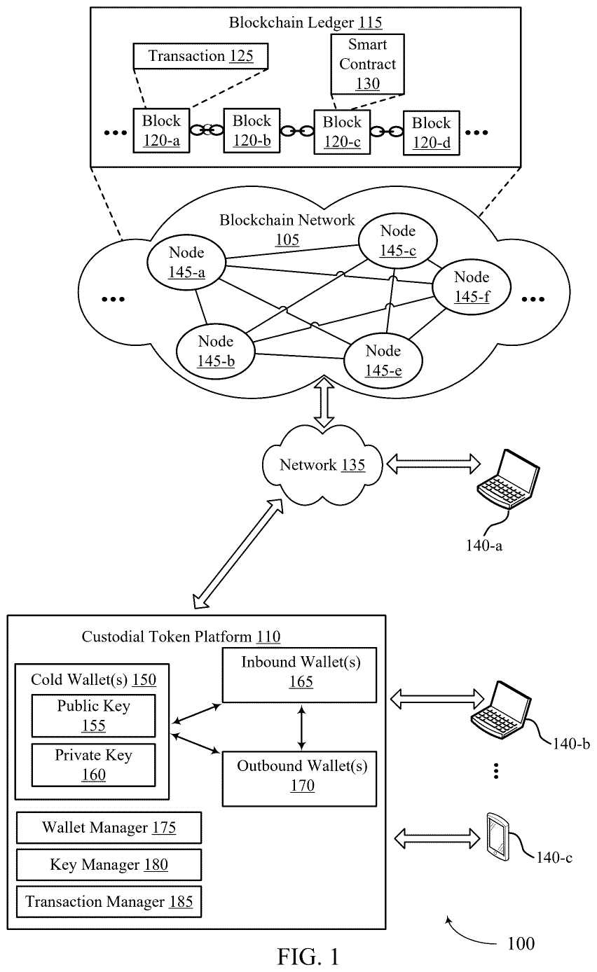

FIG. 1 illustrates an example of a computing environment 100 that supports key share refresh in association with key share operations in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the smart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

In some systems, multiple parties (e.g., computing devices 140, users) in an MPC scheme may collaborate to perform an MPC operation. For example, the private key 160 of the cold wallet 150 may be used or accessed via an MPC scheme described herein. As part of the MPC scheme, a cryptographic key (e.g., the private key 160) may be distributed, via multiple key shares, to multiple parties. For example, a cryptographic key, which may be an example of a secret signing key or a secret encryption key, may be split into multiple parts via a key sharing operation. In some cases, a threshold quantity or all of the multiple parties having the key shares of the cryptographic key (i.e., t out of n key shares) may, together, perform an MPC operation. In other words, the threshold quantity of key shares may be required to execute the MPC operation. In some examples, distributing the key shares to different parties may increase security and reduce the risk of an attacker successfully acquiring the key. However, in some cases, an attacker may target each party individually to acquire the individual key shares. An attacker may target the individual parties over a long period of time to avoid raising an alarm.

In some cases, the parties of the MPC scheme may perform or be subject to a key share refresh operation. For example, a key share refresh operation may refer to the generation of new key shares which are different from previous key shares but correspond to the same key. In the example of the MPC scheme, the parties having the key shares may generate new key shares corresponding to the same cryptographic key as the original key shares. In some cases, the key share refresh operation may support proactive security. For example, the key shares may be refreshed before an attacker obtains all or a threshold quantity of key shares associated with execution of the MPC operation. In other words, while the attacker may obtain a first key share and, at a later time, a second key share, the first key share may not be compatible with the second key share due to a key share refresh operation occurring before the second key share is obtained.

The key share refresh operation may be an example of a cryptographic operation performed according to an MPC scheme. To perform the key share refresh operation, each party may bring respective key shares online (e.g., accessible at a network 135) to coordinate with the other parties for the key share refresh operation. Bringing the key shares online may expose the key shares to potential attackers. For example, the key shares may be stored securely at the respective parties unless a cryptographic operation requiring the key shares or a key share refresh operation is performed. The key shares may be brought online and made accessible via the network 135, providing an attack surface for attackers to attempt to steal key shares or the key.

The techniques described herein support refreshing key shares when key shares are brought online for a different cryptographic operation. For example, a party (e.g., entity) may receive a request to perform a cryptographic operation using a key share of a cryptographic key (e.g., the private key 160), where one or more other parties may possess other key shares for the cryptographic key. The parties may execute the cryptographic operation, which may include bringing the key shares online during a network session (e.g., for the network 135). During the same network session, the parties may coordinate to perform a key share refresh operation. For example, the same network session may be used to perform the cryptographic operation and the key share refresh operation, which may reduce the exposure of the key shares and reduce the vulnerability of the key shares.

In some cases, if a threshold duration passes after a key share refresh operation (e.g., during the same network session as a cryptographic operation), the parties may perform a second key share refresh operation, separate from another cryptographic operation. For example, to ensure the key shares may be refreshed periodically, the parties may perform key share refresh operations without associated cryptographic operations. In some cases, the parties may perform a second cryptographic operation and may not perform a key share refresh operation during the same network session. For example, the second cryptographic operation may be within a threshold duration from the cryptographic operation associated with the key share refresh operation. To reduce the time, energy consumption, and overhead associated with performing a key share refresh operation, if the key shares are not within a threshold period of time in which the key shares are to be refreshed, the parties may skip refreshing the key shares and may perform the second cryptographic operation without an associated key share refresh operation.

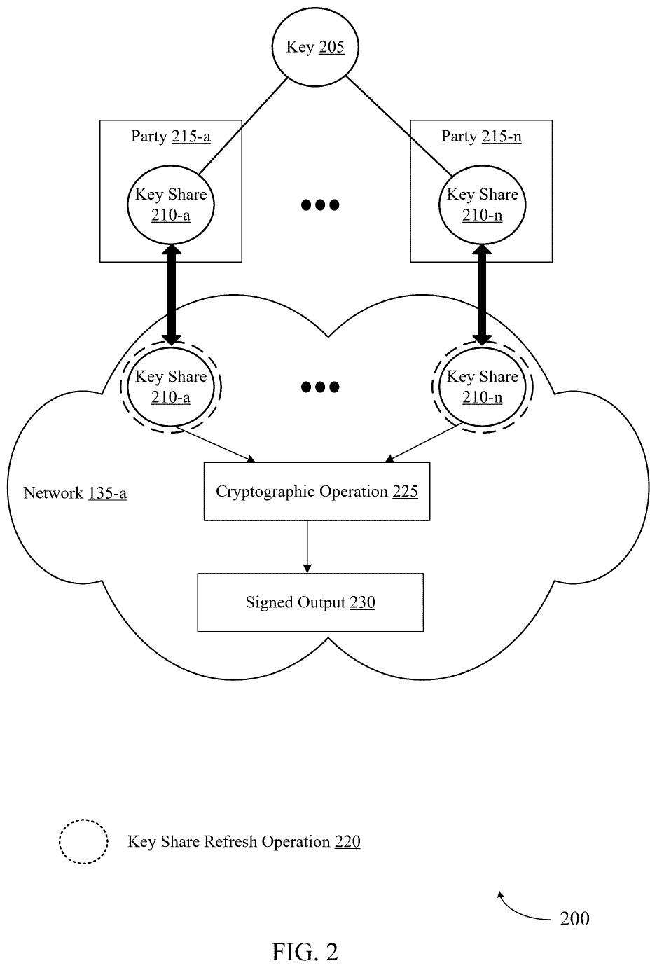

FIG. 2 shows an example of a key share refresh diagram 200 that supports key share refresh in association with key share operations in accordance with aspects of the present disclosure. The key share refresh diagram 200 may implement or be implemented to realize aspects of the computing environment 100. For example, the key share refresh diagram 200 may illustrate operations at a network 105, such as a network 135-a, which may be examples of corresponding networks described herein, including with reference to FIG. 1 (e.g., network 135). Key share refresh diagram 200 may support refreshing key shares 210 during a same network session as a cryptographic operation 225.

In some cases, multiple parties 215 in an MPC scheme may collaborate to perform an MPC operation. As part of the MPC scheme, a cryptographic key 205 may be distributed, via multiple key shares 210, to the multiple parties 215. For example, a cryptographic key 205, which may be an example of a secret signing key or a secret encryption key, may be split into multiple parts via a key sharing operation. In some cases, a threshold quantity or all of the multiple parties 215 having the key shares 210 of the cryptographic key 205 (i.e., t out of n key shares) may, together, perform an MPC operation. In other words, the threshold quantity of key shares 210 may be required to execute the MPC operation. In some cases, the threshold quantity may be a full threshold, which may require each party 215 with a key share 210 to execute the MPC operation using the key shares 210. In other cases, the threshold quantity may be a partial threshold, which may require a subset of parties 215, each with a key share 210, to execute the MPC operation using a subset of key shares 210.

In some cases, the parties 215 of the MPC scheme may perform or be subject to a key share refresh operation 220. For example, a key share refresh operation may refer to the generation of new key shares 210 which are different from previous key shares 210 but correspond to the same cryptographic key 205. In the example of the MPC scheme, the parties 215 having the key shares 210 may generate new key shares 210 corresponding to the same cryptographic key 205 as the original key shares 210. In some cases, the key share refresh operation 220 may support proactive security. For example, the key shares 210 may be refreshed before an attacker obtains all or a threshold quantity of key shares 210 associated with execution of the MPC operation. In other words, while the attacker may obtain a first key share 210-a and, at a later time, a second key share 210-n, the first key share 210-a may not be compatible with the second key share 210-n due to a key share refresh operation 220 occurring before the second key share 210-n may be obtained. In some examples, key share refresh operations 220 may be performed periodically.

To perform a key share refresh operation 220, the parties 215 may bring the respective key shares 210 online, or may make the key shares accessible via a network 135-a. For example, a party 215-a may have a key share 210-a. When the party 215-a is not performing a cryptographic operation or key share refresh operation using the key share 210-a, the key share 210-a is stored and may be inaccessible by the network 135-a. However, when the party 215-a participates in a cryptographic operation 225, the party 215-a may bring the key share 210-a online during a network session for a network 135-a. Additionally, or alternatively, when a key share 210 is refreshed, the party 215-a may bring the key share 210-a online. In some examples, the key share refresh operation may be an example of an MPC cryptographic operation. Similarly, other parties, such as the party 215-n, may bring respective key shares 210 online to perform cryptographic operations 225 and key share refresh operations 220. Bringing the key shares 210 online may expose the key shares 210, and the corresponding cryptographic key 205, to attack. For example, the network 135-a may provide an attack surface or access point for an attacker to attempt to acquire the key shares 210.

To reduce key share exposure and thus reduce the vulnerability of the cryptographic key 205, parties 215 may perform key share refresh operations 220 for the key shares 210 before or after (e.g., in response to) usage of the key shares 210 for a cryptographic operation 225. For example, parties 215, such as party 215-a and party 215-n, may determine to perform a cryptographic operation 225 (e.g., based on a request). The parties 215 may bring their respective key shares 210 online at the network 135-a. The parties 215 may perform the cryptographic operation 225 according to an MPC scheme. For example, a threshold quantity of key shares 210 may be used to sign an output 230 of the cryptographic operation. In some examples, such as for a blockchain network, the signed output 230 may be a blockchain transaction, and may be broadcast on a blockchain network (e.g., blockchain network 105), which may be separate from the network 135-a. While the key shares 210 may already be online to perform the cryptographic operation 225, the parties 215 may also coordinate a key share refresh operation 220. For example, the key shares 210 may be refreshed, before or after the cryptographic operation 225, but while the key shares 210 may still be accessible by the network 135-a (e.g., during a same network session). This may limit the exposure of the key shares 210, reducing the vulnerability of the key shares 210 and improving security for the system.

In some cases, a key share refresh operation 220 may also be performed periodically. For example, a first key share refresh operation may occur when the key shares 210 may be used for the cryptographic operation 225, such as a signing operation. However, if the first key share refresh operation 220 occurred a threshold period of time in the past, the key shares 210 may be refreshed in a separate operation. For example, the parties 215 may, at regular intervals, refresh key shares 210 that may not have been refreshed recently (e.g., as part of a cryptographic operation 225).

To support refreshing key shares 210 that may not have been refreshed within a time interval, the parties 215 may keep track of which key shares 210 have been refreshed, as well as when they have been refreshed. For example, the parties 215 may maintain a roster of what key shares 210 have been refreshed or, additionally, or alternatively, what key shares 210 have been used for cryptographic operations 225 (e.g., have been refreshed based on usage).

In some cases, key shares 210 may be refreshed whenever a key share 210 is brought online to perform a cryptographic operation 225. In other cases, the key shares 210 may be refreshed if a last refresh occurred a threshold duration in the past. For example, to avoid excessive key share refresh operations 220 that may increase complexity, signaling, and energy consumption, key share refresh operations 220 may be performed based on (e.g., before, after, or in response to) usage a threshold time after a previous key share refresh operation 220.

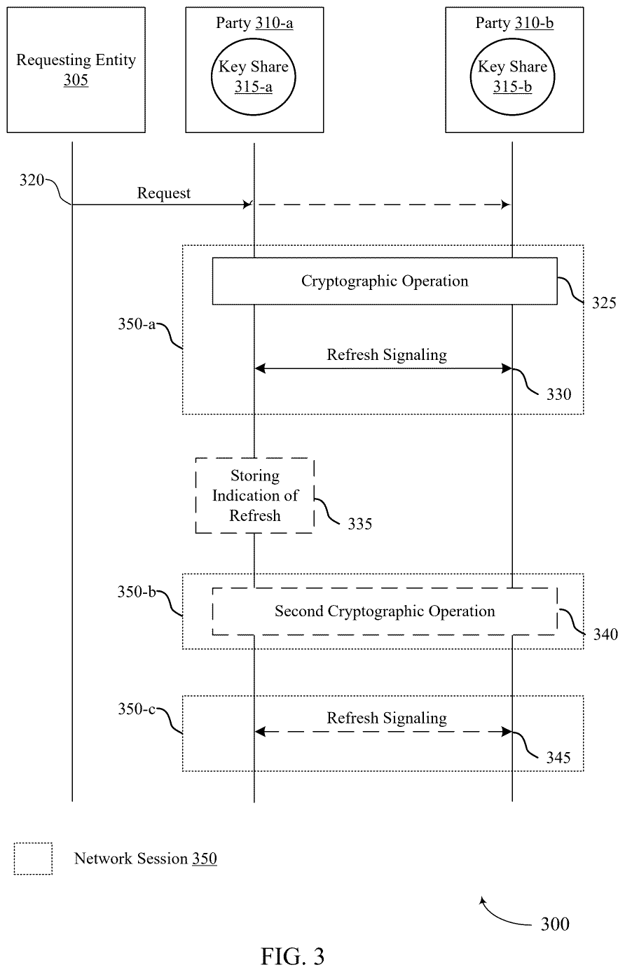

FIG. 3 shows an example of a process flow 300 that supports key share refresh in association with key share operations in accordance with aspects of the present disclosure. The process flow 300 may implement or be implemented to realize aspects of the computing environment 100 and the key share refresh diagram 200. Process flow 300 may support refreshing key shares 315 during a same network session 350 as a cryptographic operation 325.

At 320, a requesting entity 305 may transmit, to an entity that possesses a key share of multiple key shares of a cryptographic key (e.g., a party 310), a request to perform a cryptographic operation using the key share 315. One or more other entities (e.g., parties 310) may possess respective other key shares 315 of the multiple key shares. For example, the party 310-a that may possess a key share 315-a of a cryptographic key may receive a request to perform the cryptographic operation using the key share 315-a. In some cases, the requesting entity 305 may be a server, a system, an entity that may not possess a key share, or any combination thereof. Additionally, or alternatively, the requesting entity 305 may be an entity of the multiple entities (e.g., a party 310), such as a primary entity or lead entity. The requesting entity 305 may thus execute the cryptographic operation at 325 with the parties 310.

In some cases, the requesting entity 305 may transmit the request to the party 310-a. In some examples, the requesting entity 305 may also transmit the request to one or more other parties 310 (e.g., entities of the multiple entities), such as the party 310-b. In other examples, the party 310-a may act as a lead party 310 or primary party 310 and may indicate to the other parties 310 of the request form the requesting entity 305.

At 325, the party 310-a may execute, with the one or more other parties 310 (e.g., party 310-b) after receiving the request at 320, the cryptographic operation using the key share 315-a. To perform the cryptographic operation at 325, the key share 315-a and other key shares 315 that may be used for the cryptographic operation at 325 may be brought online during a network session 350-a. For example, the key shares 315 may be accessible by the network during the network session 350-a. In some examples, executing the cryptographic operation at 325 may include the party 310-a executing a multi-party signing operation for a blockchain transaction. The multi-party signing operation may include a full threshold signing operation associated with the party 310-a and the one or more other parties 310 (e.g., all parties 310 holding a key share 315 may sign the blockchain transaction), a partial threshold signing operation associated with the party 310-a and at least a subset of the one or more other parties 310 (e.g., a threshold quantity of parties 310 holding key shares 315 may sign the blockchain transaction), or any combination thereof.

At 330, the party 310-a may communicate, after receiving the request at 320 and with the one or more other entities (e.g., parties 310), first messaging configured to refresh the key share 315-a and the respective other key shares 315 (e.g., key share 315-b) for the one or more other entities. After communicating the first messaging, the entity may possess a new key share 315-a of the cryptographic key and the one or more other entities may possess new respective other key shares 315 of the cryptographic key. In some cases, communicating the first messaging configured to refresh the respective other key shares may be based on one or more rules associated with execution of the cryptographic operation at 325. The one or more rules may indicate that execution of the cryptographic operation at 325 may be accompanied by communicating the first messaging. For example, the one or more rules may indicate that respective key shares 315 may be refreshed after being brought online for usage of the key share for the cryptographic operation at 325 during the network session 350-a In some cases, executing the cryptographic operation at 325 and communicating the first messaging at 330 may occur during a network session 350-a, where at least the key share 315-a for the party 310-a may be accessible by a network during the network session 350-a.

In some cases, the parties 310 may execute a MPC operation to refresh the key share 315-a for the party 310-a and the respective key shares 315 for the one or more other parties 310. The party 310-a and the one or more other parties 310 may be part of an MPC system. For example, the first messaging at 330 may trigger (e.g., initiate, coordinate) the execution of an MPC key share refresh operation during the network session 350-a. In some cases, communicating the first messaging at 330, and, in some examples, the associated MPC operation to refresh the key shares 315, may occur after executing the cryptographic operation at 325. For example, the parties 310 may execute the cryptographic operation at 325 with the keys shares 315, such as signing a blockchain transaction using the key shares 315. In other cases, communicating the first messaging at 330, and, in some examples, the associated MPC operation to refresh the key shares 315, may occur prior to executing the cryptographic operation at 325. For example, the parties 310 may execute the cryptographic operation at 325 with the new key shares 315 (e.g., refreshed key shares 315), such as signing a blockchain transaction using the new key shares 315.

In some cases, at 335, the party 310-a may store an indication that the first messaging configured to refresh the respective other key shares 315 has been communicated at 335. For example, the party 310-a may maintain a roster or registry of when the key shares 315 may be refreshed or may be used. In some examples, each party 310 may store a separate indication of the first messaging. For example, party 310-b may also store an indication that the first messaging configured to refresh the key shares 315 has been communicated. In some examples, the indication may be stored to a shared roster or registry between the parties 310. In some examples, a subset of parties 310 may store the indication (e.g., a lead or primary party 310-a).

In some cases, at 340, the party 310-a may execute, with the one or more other parties 310 (e.g., entities), a second cryptographic operation using the new key share 315-a(e.g., the refreshed key share 315-a). The party 310-a may refrain from communicating with the one or more other parties 310 second messaging configured to refresh the new key share 315-a for the party 310-a and the new respective other key shares 315 (e.g., key share 315-b) for the one or more other parties 310. Refraining from communicating the second messaging may be based on a time period after the refresh of the respective other key shares (e.g., at 330) failing to satisfy a threshold time amount. For example, the cryptographic operation at 325 and the associated refresh signaling at 330, within the network session 350-a, may occur within a threshold time period to the second cryptographic operation at 340. The parties 310 may not refresh the key shares during the network session 350-b, associated with the second cryptographic operation 340, to avoid excessive or unnecessary key share refresh.

In some cases, at 345, the party 310-a may communicate with the one or more other parties 310 (e.g., party 310-b) second messaging configured to refresh the new key share for the party 310-b and the one or more other parties 310-b. Communicating the second messaging may be based on a time period after the refresh of the respective key shares (e.g., at 330) satisfying a threshold time amount before an intermediate key share refresh occurs. For example, after 330, a threshold period of time may pass (e.g., based on periodic key share refresh), and the parties 310 may bring the respective key shares 315 online during a network session 350-c, without an associated cryptographic operation, to refresh the key shares 315. This may maintain proactive security for the key shares 315.

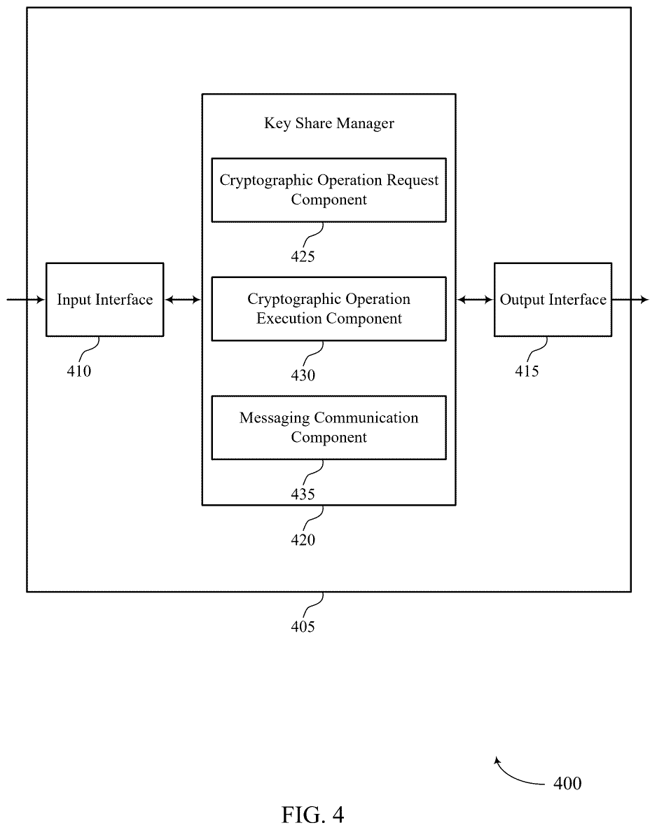

FIG. 4 shows a block diagram 400 of a system 405 that supports key share refresh in association with key share operations in accordance with aspects of the present disclosure. The system 405 may include an input interface 410, an output interface 415, and a key share manager 420. The system 405, or one or more components of the system 405 (e.g., the input interface 410, the output interface 415, the key share manager 420), may include at least one processor, which may be coupled with at least one memory, to support the described techniques. Each of these components may communicate, directly or indirectly, with one another (e.g., via one or more buses, communications links, communications interfaces, or any combination thereof).

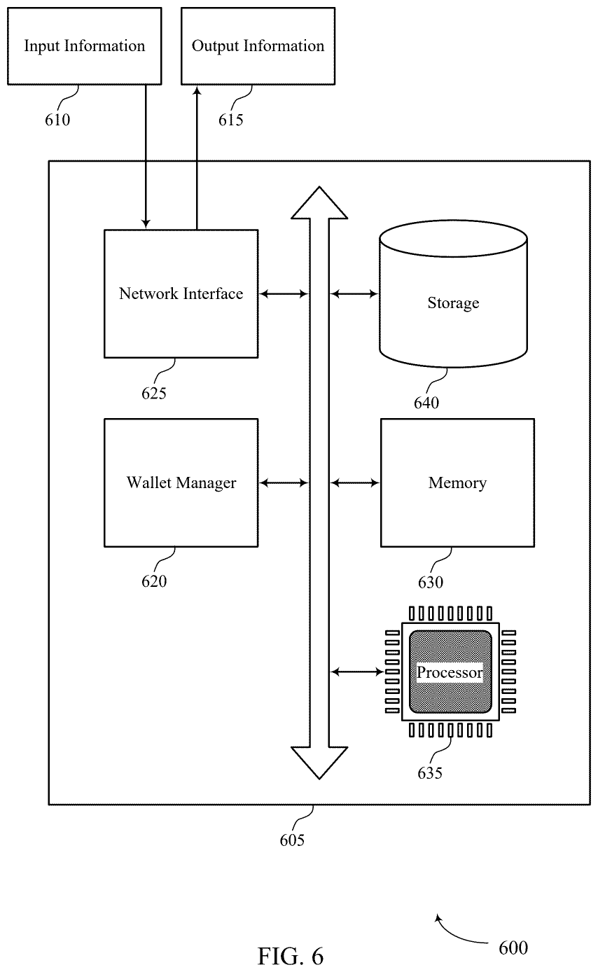

The input interface 410 may manage input signaling for the system 405. For example, the input interface 410 may receive input signaling (e.g., messages, packets, data, instructions, commands, transactions, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the key share manager 420 to support key share refresh in association with key share operations. In some cases, the input interface 410 may be a component of a network interface 625 as described with reference to FIG. 6.

The output interface 415 may manage output signaling for the system 405. For example, the output interface 415 may receive signaling from other components of the system 405, such as the key share manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the key share manager 420 may include a cryptographic operation request component 425, a cryptographic operation execution component 430, a messaging communication component 435, or any combination thereof. In some examples, the key share manager 420, or various components thereof, may be configured to perform various operations (e.g., receiving, monitoring, transmitting) using or otherwise in cooperation with the input interface 410, the output interface 415, or both. For example, the key share manager 420 may receive information from the input interface 410, send information to the output interface 415, or be integrated in combination with the input interface 410, the output interface 415, or both to receive information, transmit information, or perform various other operations as described herein.

The key share manager 420 may support key management in accordance with examples as disclosed herein. The cryptographic operation request component 425 may be configured as or otherwise support a means for receiving, at an entity that possesses a key share of a plurality of key shares of a cryptographic key, a request to perform a cryptographic operation using the key share, wherein one or more other entities possess respective other key shares of the plurality of key shares. The cryptographic operation execution component 430 may be configured as or otherwise support a means for executing, with the one or more other entities after receiving the request, the cryptographic operation using the key share. The messaging communication component 435 may be configured as or otherwise support a means for communicating, after receiving the request and with the one or more other entities, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key.

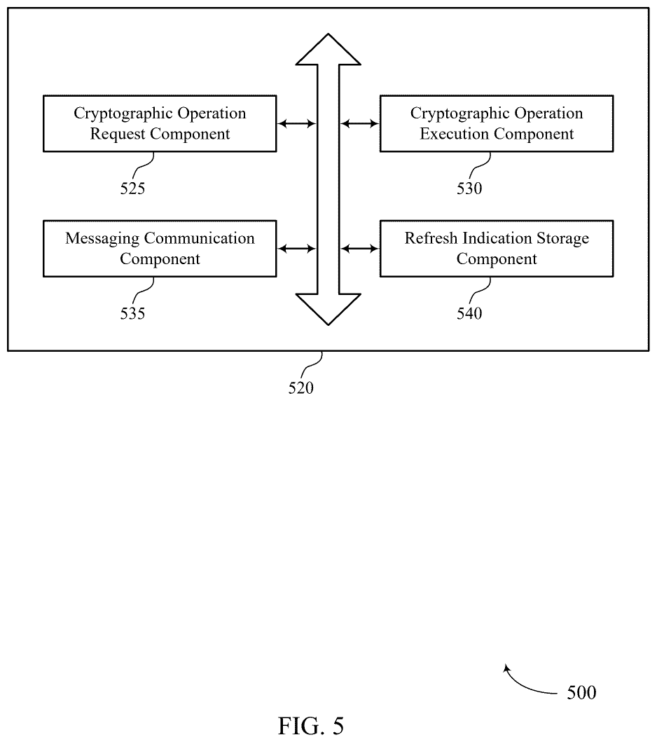

FIG. 5 shows a block diagram 500 of a key share manager 520 that supports key share refresh in association with key share operations in accordance with aspects of the present disclosure. The key share manager 520 may be an example of aspects of a key share manager or a key share manager 420, or both, as described herein. The key share manager 520, or various components thereof, may be an example of means for performing (e.g., to cause the key share manager 520 to perform) various aspects of key share refresh in association with key share operations as described herein. For example, the key share manager 520 may include a cryptographic operation request component 525, a cryptographic operation execution component 530, a messaging communication component 535, a refresh indication storage component 540, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The key share manager 520 may support key management in accordance with examples as disclosed herein. The cryptographic operation request component 525 may be configured as or otherwise support a means for receiving, at an entity that possesses a key share of a plurality of key shares of a cryptographic key, a request to perform a cryptographic operation using the key share, wherein one or more other entities possess respective other key shares of the plurality of key shares. The cryptographic operation execution component 530 may be configured as or otherwise support a means for executing, with the one or more other entities after receiving the request, the cryptographic operation using the key share. The messaging communication component 535 may be configured as or otherwise support a means for communicating, after receiving the request and with the one or more other entities, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key.

In some examples, communicating the first messaging configured to refresh the respective other key shares is based at least in part on one or more rules associated with execution of the cryptographic operation. In some examples, the one or more rules indicate that execution of the cryptographic operation is accompanied by communicating the first messaging.

In some examples, the refresh indication storage component 540 may be configured as or otherwise support a means for storing an indication that the first messaging configured to refresh the respective other key shares has been communicated.

In some examples, the cryptographic operation execution component 530 may be configured as or otherwise support a means for executing, with the one or more other entities, a second cryptographic operation using the new key share. In some examples, the messaging communication component 535 may be configured as or otherwise support a means for refraining from communicating with the one or more other entities second messaging configured to refresh the new key share for the entity and the new respective other key shares for the one or more other entities, wherein refraining from communicating the second messaging is based at least in part on a time period after the refresh of the respective other key shares failing to satisfy a threshold time amount.

In some examples, the messaging communication component 535 may be configured as or otherwise support a means for communicating with the one or more other entities second messaging configured to refresh the new key share for the entity and the new respective other key shares for the one or more other entities, wherein communicating the second messaging is based at least in part on a time period after the refresh of the respective other key shares satisfying a threshold time amount before an intermediate key share refresh occurs.

In some examples, the cryptographic operation execution component 530 may be configured as or otherwise support a means for executing a multi-party computation operation to refresh the key share for the entity and the respective other key shares for the one or more other entities, wherein the entity and the one or more other entities are part of a multi-party computation system.

In some examples, to support executing the cryptographic operation, the cryptographic operation execution component 530 may be configured as or otherwise support a means for executing a multi-party computation operation with the one or more other entities, wherein the entity and the one or more other entities are part of a multi-party computation system.

In some examples, to support executing the cryptographic operation, the cryptographic operation execution component 530 may be configured as or otherwise support a means for executing a multi-party signing operation for a blockchain transaction, wherein the multi-party signing operation comprises a full threshold signing operation associated with the entity and the one or more other entities, a partial threshold signing operation associated with the entity and at least a subset of the one or more other entities, or any combination thereof.

In some examples, executing the cryptographic operation and communicating the first messaging occurs during a network session. In some examples, at least the key share for the entity is accessible by a network during the network session.

In some examples, communicating the first messaging occurs after executing the cryptographic operation.

In some examples, communicating the first messaging occurs prior to executing the cryptographic operation.

FIG. 6 shows a diagram of a system 600 including a system 605 that supports key share refresh in association with key share operations in accordance with aspects of the present disclosure. The system 605 may be an example of or include components of a system 405 as described herein. The system 605 may include components for bi-directional voice and data communications including components for transmitting and receiving communications, such as a key share manager 620, an input information 610, an output information 615, a network interface 625, at least one memory 630, at least one processor 635, a storage 640, and a key share manager 620. Each of these components, or components of subcomponents thereof (e.g., one or more processors, one or more memories), may communicate, directly or indirectly, with one another (e.g., via one or more buses, communications links, communications interfaces, or any combination thereof).

The network interface 625 may enable the system 605 to exchange information (e.g., input information 610, output information 615, or both) with other systems or devices (not shown). For example, the network interface 625 may enable the system 605 to connect to a network (e.g., a network 135 as described herein). The network interface 625 may include one or more wireless network interfaces, one or more wired network interfaces, or any combination thereof.

Memory 630 may include RAM, ROM, or both. The memory 630 may store computer-readable, computer-executable software including instructions that, when executed, cause at least one processor 635 to perform various functions described herein, such as functions supporting key share refresh in association with key share operations. In some cases, the memory 630 may contain, among other things, a basic input/output system (BIOS), which may control basic hardware or software operation such as the interaction with peripheral components or devices. In some cases, the memory 630 may be an example of aspects of one or more components of a custodial token platform 110 as described with reference to FIG. 1. The memory 630 may be an example of a single memory or multiple memories. For example, the system 605 may include one or more memories 630.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting key share refresh in association with key share operations). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. The processor 635 may be an example of a single processor or multiple processors. For example, the system 605 may include one or more processors 635.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1.

The key share manager 620 may support key management in accordance with examples as disclosed herein. For example, the key share manager 620 may be configured as or otherwise support a means for receiving, at an entity that possesses a key share of a plurality of key shares of a cryptographic key, a request to perform a cryptographic operation using the key share, wherein one or more other entities possess respective other key shares of the plurality of key shares. The key share manager 620 may be configured as or otherwise support a means for executing, with one or more other entities after receiving the request, the cryptographic operation using the key share. The key share manager 620 may be configured as or otherwise support a means for communicating, after receiving the request and with the one or more other entities, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key.

By including or configuring the key share manager 620 in accordance with examples as described herein, the system 605 may support techniques for improved security related to reduced instances of exposure for key shares, reduced vulnerability of key shares, reduced power consumption, and more efficient utilization of network sessions.

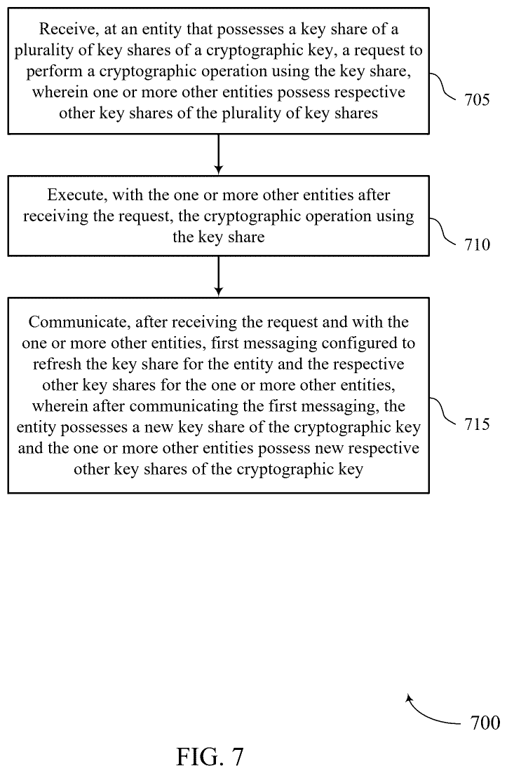

FIG. 7 shows a flowchart illustrating a method 700 that supports key share refresh in association with key share operations in accordance with aspects of the present disclosure. The operations of the method 700 may be implemented by a custodial token platform or its components as described herein. For example, the operations of the method 700 may be performed by a custodial token platform as described with reference to FIGS. 1 through 6. In some examples, a custodial token platform may execute a set of instructions to control the functional elements of the custodial token platform to perform the described functions. Additionally, or alternatively, the custodial token platform may perform aspects of the described functions using special-purpose hardware.

At 705, the method may include receiving, at an entity that possesses a key share of a plurality of key shares of a cryptographic key, a request to perform a cryptographic operation using the key share, wherein one or more other entities possess respective other key shares of the plurality of key shares. The operations of 705 may be performed in accordance with examples as disclosed herein. In some examples, aspects of the operations of 705 may be performed by a cryptographic operation request component 525.

At 710, the method may include executing, with the one or more other entities after receiving the request, the cryptographic operation using the key share. The operations of 710 may be performed in accordance with examples as disclosed herein. In some examples, aspects of the operations of 710 may be performed by a cryptographic operation execution component 530.

At 715, the method may include communicating, after receiving the request and with the one or more other entities, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key. The operations of 715 may be performed in accordance with examples as disclosed herein. In some examples, aspects of the operations of 715 may be performed by a messaging communication component 535.

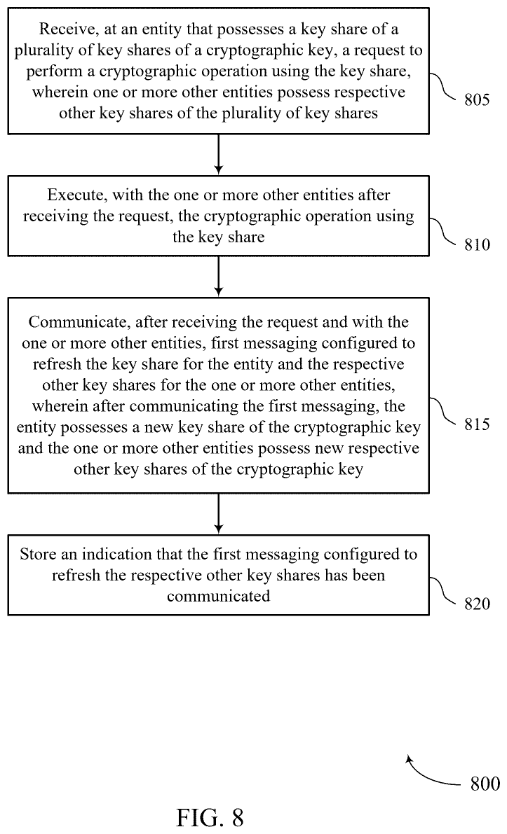

FIG. 8 shows a flowchart illustrating a method 800 that supports key share refresh in association with key share operations in accordance with aspects of the present disclosure. The operations of the method 800 may be implemented by a custodial token platform or its components as described herein. For example, the operations of the method 800 may be performed by a custodial token platform as described with reference to FIGS. 1 through 6. In some examples, a custodial token platform may execute a set of instructions to control the functional elements of the custodial token platform to perform the described functions. Additionally, or alternatively, the custodial token platform may perform aspects of the described functions using special-purpose hardware.

At 805, the method may include receiving, at an entity that possesses a key share of a plurality of key shares of a cryptographic key, a request to perform a cryptographic operation using the key share, wherein one or more other entities possess respective other key shares of the plurality of key shares. The operations of 805 may be performed in accordance with examples as disclosed herein. In some examples, aspects of the operations of 805 may be performed by a cryptographic operation request component 525.

At 810, the method may include executing, with the one or more other entities after receiving the request, the cryptographic operation using the key share. The operations of 810 may be performed in accordance with examples as disclosed herein. In some examples, aspects of the operations of 810 may be performed by a cryptographic operation execution component 530.

At 815, the method may include communicating, after receiving the request and with the one or more other entities, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key. The operations of 815 may be performed in accordance with examples as disclosed herein. In some examples, aspects of the operations of 815 may be performed by a messaging communication component 535.

At 820, the method may include storing an indication that the first messaging configured to refresh the respective other key shares has been communicated. The operations of 820 may be performed in accordance with examples as disclosed herein. In some examples, aspects of the operations of 820 may be performed by a refresh indication storage component 540.

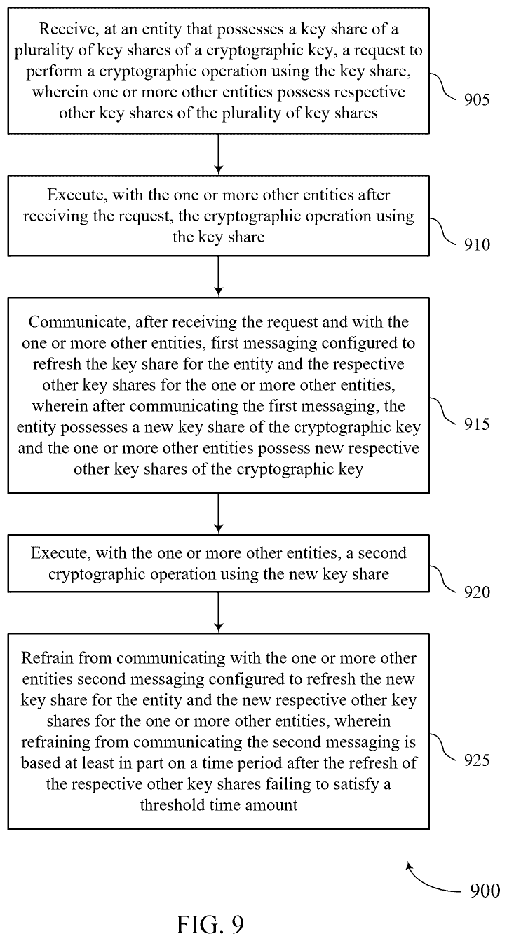

FIG. 9 shows a flowchart illustrating a method 900 that supports key share refresh in association with key share operations in accordance with aspects of the present disclosure. The operations of the method 900 may be implemented by a custodial token platform or its components as described herein. For example, the operations of the method 900 may be performed by a custodial token platform as described with reference to FIGS. 1 through 6. In some examples, a custodial token platform may execute a set of instructions to control the functional elements of the custodial token platform to perform the described functions. Additionally, or alternatively, the custodial token platform may perform aspects of the described functions using special-purpose hardware.

At 905, the method may include receiving, at an entity that possesses a key share of a plurality of key shares of a cryptographic key, a request to perform a cryptographic operation using the key share, wherein one or more other entities possess respective other key shares of the plurality of key shares. The operations of 905 may be performed in accordance with examples as disclosed herein. In some examples, aspects of the operations of 905 may be performed by a cryptographic operation request component 525.

At 910, the method may include executing, with the one or more other entities after receiving the request, the cryptographic operation using the key share. The operations of 910 may be performed in accordance with examples as disclosed herein. In some examples, aspects of the operations of 910 may be performed by a cryptographic operation execution component 530.

At 915, the method may include communicating, after receiving the request and with the one or more other entities, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key. The operations of 915 may be performed in accordance with examples as disclosed herein. In some examples, aspects of the operations of 915 may be performed by a messaging communication component 535.

At 920, the method may include executing, with the one or more other entities, a second cryptographic operation using the new key share. The operations of 920 may be performed in accordance with examples as disclosed herein. In some examples, aspects of the operations of 920 may be performed by a cryptographic operation execution component 530.

At 925, the method may include refraining from communicating with the one or more other entities second messaging configured to refresh the new key share for the entity and the new respective other key shares for the one or more other entities, wherein refraining from communicating the second messaging is based at least in part on a time period after the refresh of the respective other key shares failing to satisfy a threshold time amount. The operations of 925 may be performed in accordance with examples as disclosed herein. In some examples, aspects of the operations of 925 may be performed by a messaging communication component 535.

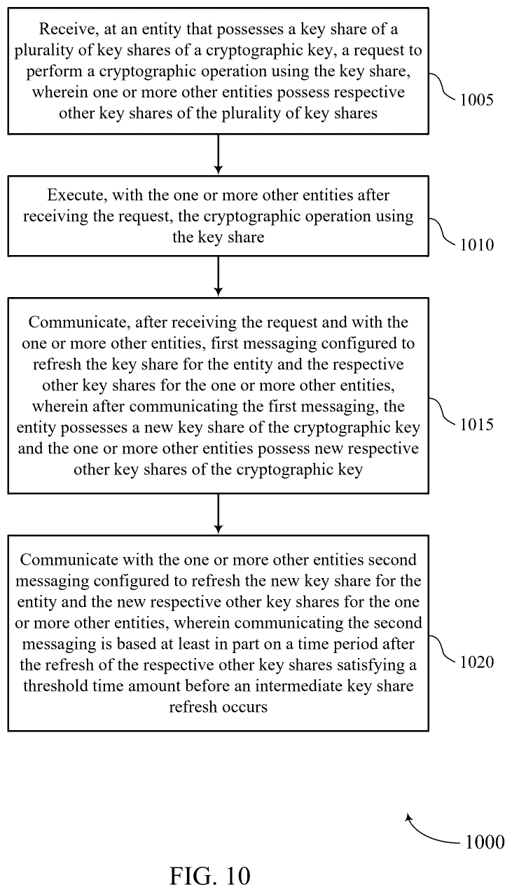

FIG. 10 shows a flowchart illustrating a method 1000 that supports key share refresh in association with key share operations in accordance with aspects of the present disclosure. The operations of the method 1000 may be implemented by a custodial token platform or its components as described herein. For example, the operations of the method 1000 may be performed by a custodial token platform as described with reference to FIGS. 1 through 6. In some examples, a custodial token platform may execute a set of instructions to control the functional elements of the custodial token platform to perform the described functions. Additionally, or alternatively, the custodial token platform may perform aspects of the described functions using special-purpose hardware.

At 1005, the method may include receiving, at an entity that possesses a key share of a plurality of key shares of a cryptographic key, a request to perform a cryptographic operation using the key share, wherein one or more other entities possess respective other key shares of the plurality of key shares. The operations of 1005 may be performed in accordance with examples as disclosed herein. In some examples, aspects of the operations of 1005 may be performed by a cryptographic operation request component 525.

At 1010, the method may include executing, with the one or more other entities after receiving the request, the cryptographic operation using the key share. The operations of 1010 may be performed in accordance with examples as disclosed herein. In some examples, aspects of the operations of 1010 may be performed by a cryptographic operation execution component 530.

At 1015, the method may include communicating, after receiving the request and with the one or more other entities, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key. The operations of 1015 may be performed in accordance with examples as disclosed herein. In some examples, aspects of the operations of 1015 may be performed by a messaging communication component 535.

At 1020, the method may include communicating with the one or more other entities second messaging configured to refresh the new key share for the entity and the new respective other key shares for the one or more other entities, wherein communicating the second messaging is based at least in part on a time period after the refresh of the respective other key shares satisfying a threshold time amount before an intermediate key share refresh occurs. The operations of 1020 may be performed in accordance with examples as disclosed herein. In some examples, aspects of the operations of 1020 may be performed by a messaging communication component 535.

A method for key management by an apparatus is described. The method may include receiving, at an entity that possesses a key share of a plurality of key shares of a cryptographic key, a request to perform a cryptographic operation using the key share, wherein one or more other entities possess respective other key shares of the plurality of key shares, executing, with the one or more other entities after receiving the request, the cryptographic operation using the key share, and communicating, after receiving the request and with the one or more other entities, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key.

An apparatus for key management is described. The apparatus may include one or more memories storing processor executable code, and one or more processors coupled with the one or more memories. The one or more processors may individually or collectively be operable to execute the code to cause the apparatus to receive, at an entity that possesses a key share of a plurality of key shares of a cryptographic key, a request to perform a cryptographic operation using the key share, wherein one or more other entities possess respective other key shares of the plurality of key shares, execute, with the one or more other entities after receiving the request, the cryptographic operation using the key share, and communicate, after receiving the request and with the one or more other entities, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key.

Another apparatus for key management is described. The apparatus may include means for receiving, at an entity that possesses a key share of a plurality of key shares of a cryptographic key, a request to perform a cryptographic operation using the key share, wherein one or more other entities possess respective other key shares of the plurality of key shares, means for executing, with the one or more other entities after receiving the request, the cryptographic operation using the key share, and means for communicating, after receiving the request and with the one or more other entities, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key.

A non-transitory computer-readable medium storing code for key management is described. The code may include instructions executable by one or more processors to receive, at an entity that possesses a key share of a plurality of key shares of a cryptographic key, a request to perform a cryptographic operation using the key share, wherein one or more other entities possess respective other key shares of the plurality of key shares, execute, with the one or more other entities after receiving the request, the cryptographic operation using the key share, and communicate, after receiving the request and with the one or more other entities, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key.

Some examples of the method, apparatus, and non-transitory computer-readable medium described herein may further include operations, features, means, or instructions for communicating the first messaging configured to refresh the respective other key shares may be based at least in part on one or more rules associated with execution of the cryptographic operation and the one or more rules indicate that execution of the cryptographic operation may be accompanied by communicating the first messaging.

Some examples of the method, apparatus, and non-transitory computer-readable medium described herein may further include operations, features, means, or instructions for storing an indication that the first messaging configured to refresh the respective other key shares may have been communicated.

Some examples of the method, apparatus, and non-transitory computer-readable medium described herein may further include operations, features, means, or instructions for executing, with the one or more other entities, a second cryptographic operation using the new key share and refraining from communicating with the one or more other entities second messaging configured to refresh the new key share for the entity and the new respective other key shares for the one or more other entities, wherein refraining from communicating the second messaging may be based at least in part on a time period after the refresh of the respective other key shares failing to satisfy a threshold time amount.

Some examples of the method, apparatus, and non-transitory computer-readable medium described herein may further include operations, features, means, or instructions for communicating with the one or more other entities second messaging configured to refresh the new key share for the entity and the new respective other key shares for the one or more other entities, wherein communicating the second messaging may be based at least in part on a time period after the refresh of the respective other key shares satisfying a threshold time amount before an intermediate key share refresh occurs.

Some examples of the method, apparatus, and non-transitory computer-readable medium described herein may further include operations, features, means, or instructions for executing a multi-party computation operation to refresh the key share for the entity and the respective other key shares for the one or more other entities, wherein the entity and the one or more other entities may be part of a multi-party computation system.

In some examples of the method, apparatus, and non-transitory computer-readable medium described herein, executing the cryptographic operation may include operations, features, means, or instructions for executing a multi-party computation operation with the one or more other entities, wherein the entity and the one or more other entities may be part of a multi-party computation system.

In some examples of the method, apparatus, and non-transitory computer-readable medium described herein, executing the cryptographic operation may include operations, features, means, or instructions for executing a multi-party signing operation for a blockchain transaction, wherein the multi-party signing operation comprises a full threshold signing operation associated with the entity and the one or more other entities, a partial threshold signing operation associated with the entity and at least a subset of the one or more other entities, or any combination thereof.

Some examples of the method, apparatus, and non-transitory computer-readable medium described herein may further include operations, features, means, or instructions for executing the cryptographic operation and communicating the first messaging occurs during a network session and at least the key share for the entity may be accessible by a network during the network session.

Some examples of the method, apparatus, and non-transitory computer-readable medium described herein may further include operations, features, means, or instructions for communicating the first messaging occurs after executing the cryptographic operation.

Some examples of the method, apparatus, and non-transitory computer-readable medium described herein may further include operations, features, means, or instructions for communicating the first messaging occurs prior to executing the cryptographic operation.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for key management, comprising:
receiving, at an entity that possesses a key share of a plurality of key shares of a cryptographic key, a request to perform a cryptographic operation using the key share, wherein one or more other entities possess respective other key shares of the plurality of key shares;
executing, with the one or more other entities after receiving the request, the cryptographic operation using the key share; and
communicating, after receiving the request and with the one or more other entities, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key.

2. The method of claim 1, wherein communicating the first messaging configured to refresh the respective other key shares is based at least in part on one or more rules associated with execution of the cryptographic operation, wherein the one or more rules indicate that execution of the cryptographic operation is accompanied by communicating the first messaging.

3. The method of claim 1, further comprising:
storing an indication that the first messaging configured to refresh the respective other key shares has been communicated.

4. The method of claim 1, further comprising:
executing, with the one or more other entities, a second cryptographic operation using the new key share; and
refraining from communicating with the one or more other entities second messaging configured to refresh the new key share for the entity and the new respective other key shares for the one or more other entities, wherein refraining from communicating the second messaging is based at least in part on a time period after the refresh of the respective other key shares failing to satisfy a threshold time amount.

5. The method of claim 1, further comprising:
communicating with the one or more other entities second messaging configured to refresh the new key share for the entity and the new respective other key shares for the one or more other entities, wherein communicating the second messaging is based at least in part on a time period after the refresh of the respective other key shares satisfying a threshold time amount before an intermediate key share refresh occurs.

6. The method of claim 1, further comprising:
executing a multi-party computation operation to refresh the key share for the entity and the respective other key shares for the one or more other entities, wherein the entity and the one or more other entities are part of a multi-party computation system.

7. The method of claim 1, wherein executing the cryptographic operation comprises:
executing a multi-party computation operation with the one or more other entities, wherein the entity and the one or more other entities are part of a multi-party computation system.

8. The method of claim 7, wherein executing the cryptographic operation comprises:
executing a multi-party signing operation for a blockchain transaction, wherein the multi-party signing operation comprises a full threshold signing operation associated with the entity and the one or more other entities, a partial threshold signing operation associated with the entity and at least a subset of the one or more other entities, or any combination thereof.

9. The method of claim 1, wherein executing the cryptographic operation and communicating the first messaging occurs during a network session, wherein at least the key share for the entity is accessible by a network during the network session.

10. The method of claim 1, wherein communicating the first messaging occurs after executing the cryptographic operation.

11. The method of claim 1, wherein communicating the first messaging occurs prior to executing the cryptographic operation.

12. An apparatus for key management, comprising:
one or more memories storing processor-executable code; and
one or more processors coupled with the one or more memories and individually or collectively operable to execute the code to cause the apparatus to:
receive, at an entity that possesses a key share of a plurality of key shares of a cryptographic key, a request to perform a cryptographic operation using the key share, wherein one or more other entities possess respective other key shares of the plurality of key shares;
execute, with the one or more other entities after receiving the request and during a network session, the cryptographic operation using the key share; and
communicate, after receiving the request and with the one or more other entities during the network session, first messaging configured to refresh the key share for the entity and the respective other key shares for the one or more other entities, wherein after communicating the first messaging, the entity possesses a new key share of the cryptographic key and the one or more other entities possess new respective other key shares of the cryptographic key.

13. The apparatus of claim 12, wherein communicating the first messaging configured to refresh the respective other key shares is based at least in part on one or more rules associated with execution of the cryptographic operation, wherein the one or more rules indicate that execution of the cryptographic operation is accompanied by communicating the first messaging.

14. The apparatus of claim 12, wherein the one or more processors are individually or collectively further operable to execute the code to cause the apparatus to:
store an indication that the first messaging configured to refresh the respective other key shares has been communicated.

15. The apparatus of claim 12, wherein the one or more processors are individually or collectively further operable to execute the code to cause the apparatus to:
execute, with the one or more other entities, a second cryptographic operation using the new key share; and
refrain from communicating with the one or more other entities second messaging configured to refresh the new key share for the entity and the new respective other key shares for the one or more other entities, wherein refraining from communicating the second messaging is based at least in part on a time period after the refresh of the respective other key shares failing to satisfy a threshold time amount.

16. The apparatus of claim 12, wherein the one or more processors are individually or collectively further operable to execute the code to cause the apparatus to:
communicate with the one or more other entities second messaging configured to refresh the new key share for the entity and the new respective other key shares for the one or more other entities, wherein communicating the second messaging is based at least in part on a time period after the refresh of the respective other key shares satisfying a threshold time amount before an intermediate key share refresh occurs.

17. The apparatus of claim 12, wherein the one or more processors are individually or collectively further operable to execute the code to cause the apparatus to:
execute a multi-party computation operation to refresh the key share for the entity and the respective other key shares for the one or more other entities, wherein the entity and the one or more other entities are part of a multi-party computation system.

18. The apparatus of claim 12, wherein, to execute the cryptographic operation, the one or more processors are individually or collectively operable to execute the code to cause the apparatus to:
execute a multi-party computation operation with the one or more other entities, wherein the entity and the one or more other entities are part of a multi-party computation system.

19. The apparatus of claim 18, wherein, to execute the cryptographic operation, the one or more processors are individually or collectively operable to execute the code to cause the apparatus to:
execute a multi-party signing operation for a blockchain transaction, wherein the multi-party signing operation comprises a full threshold signing operation associated with the entity and the one or more other entities, a partial threshold signing operation associated with the entity and at least a subset of the one or more other entities, or any combination thereof.

20. A non-transitory computer-readable medium storing code for key management, the code comprising instructions executable by one or more processors to:
receive, at an entity that possesses a key share of a plurality of key shares of a cryptographic key, a request to perform a cryptographic operation using the key share, wherein one or more other entities possess respective other key shares of the plurality of key shares;
execute, with the one or more other entities after receiving the request, the cryptographic operation using the key share; and
communicate, after receiving the request and with the one or more other entities, first messaging configured to refresh the key share for the entity and the respective other key shares for the one or more other entities, wherein:
communicating the first messaging is based at least in part on one or more rules that indicate that execution of the cryptographic operation is accompanied by communicating the first messaging; and
after communicating the first messaging, the entity possesses a new key share of the cryptographic key and the one or more other entities possess new respective other key shares of the cryptographic key.
